(19) United States
(12) Patent Application Publication
(10) Pub. No.: US 2007/0138313 A1
(43) Pub. Date: Jun. 21, 2007

(54) Dispensing apparatus

(75) Inventor: Italo Corona, Canal San Bovo (TN) (IT)

Correspondence Address: NIXON & VANDERHYE, PC, 901 NORTH GLEBE ROAD, 11TH FLOOR, ARLINGTON, VA, 22203, US

(73) Assignee: LEOTECH S.R.L., Canal San Bovo (TN) (IT)

(21) Appl. No.: 11/604,396

(22) Filed: Nov. 27, 2006

(30) Foreign Application Priority Data
Nov. 25, 2005 (IT) MO2005A000313

(51) Int. Cl. F25C 3/04; B05B 7/04; A62C 31/00

(52) U.S. Cl. 239/14.2; 239/2.2; 239/398

(57) ABSTRACT

A dispensing apparatus for dispensing a flow of fluid, in particular water and/or air, to an apparatus for making artificial snow, comprises a dispensing valve device arranged for adjusting said flow of fluid to said apparatus and a cam device for moving a sensible member of said dispensing valve device.

The invention relates to a dispensing apparatus, in particular a dispensing apparatus arranged for dispensing a flow of water and air to an apparatus for making artificial snow and a method for driving the aforesaid dispensing apparatus.

It is known that, for making artificial snow, favourable temperature and humidity conditions and the presence of freezing nuclei are necessary.

For this reason, the apparatuses for making artificial snow comprise nucleating nozzles arranged for nebulizing a mixture comprising air and water for generating the freezing nuclei, and dispensing nozzles arranged for nebulizing water for supplying the aforesaid freezing nuclei around which snow crystals are generated with further raw material (in addition to the humidity already present in the atmosphere). The dispensing nozzles and the nucleating nozzles are arranged for operating in groups, or in series.

The nucleating nozzles may comprise a first series of nozzles, whilst the dispensing nozzles may comprise a second and a third series of nozzles.

The first series of nozzles is constantly supplied to supply water and air to the nucleating nozzles, whilst the second series and/or the third series are supplied with water only in certain temperature conditions when it is possible to make a greater quantity of artificial snow.

Dispensing apparatuses are known that are provided with solenoid valves arranged for adjusting the flow of water to an apparatus for making artificial snow.

A drawback of known dispensing apparatuses is that they need electric energy to drive the solenoid valves.

Electric energy, in addition to not being in itself cheap, requires a suitable wiring network to be installed in order to be used.

This wiring network entails considerable costs for the purchase, installation and maintenance thereof.

In particular, installation and maintenance are very difficult and laborious, inasmuch as the apparatuses for making artificial snow are often positioned in inaccessible zones located on mountain slopes that are difficult to access.

An object of the invention is to improve dispensing apparatuses, in particular dispensing apparatuses arranged for dispensing a flow of water and air to an apparatus for making artificial snow.

Another object is to obtain dispensing apparatuses provided with valves that do not need electric energy to be driven.

In a first aspect of the invention, there is provided a dispensing apparatus for dispensing a flow of fluid, in particular water and/or air, to an apparatus for making artificial snow, comprising a dispensing valve device arranged for adjusting said flow of fluid to said apparatus, characterised in that there is provided a cam device for moving a sensible member of said dispensing valve device.

In a second aspect of the invention, there is provided a method for driving a fluid dispensing apparatus, which fluid dispensing apparatus is arranged for dispensing a flow of fluid, in particular water and/or air, to an apparatus for making artificial snow, comprising controlling a dispensing valve device of said fluid dispensing apparatus, said dispensing valve device being arranged for adjusting said flow of fluid to said apparatus, characterised in that said driving comprises dispensing pressurised air to said fluid dispensing apparatus.

Owing to these aspects of the invention, it is possible to make dispensing apparatuses that can operate without using electric energy, with consequent financial savings.

In particular, it is possible to obtain dispensing apparatuses that are drivable by means of compressed air.

In this way, electric cables are no longer necessary for conveying the electric energy, with consequent reduction of the costs connected therewith.

The invention can be better understood and implemented with reference to the attached drawings, which illustrate some embodiments thereof by way of non-limiting example, in which:

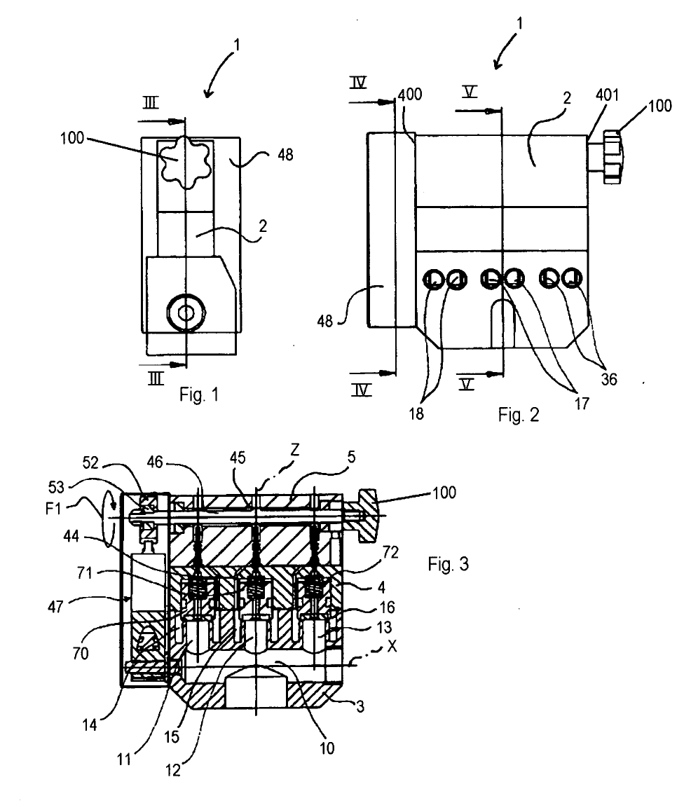

FIG. 1 is a lateral side view of a dispensing apparatus;

FIG. 2 is a frontal schematic view of the dispensing apparatus in FIG. 1;

FIG. 3 is a schematic section taken along the plane III-III of the dispensing apparatus in FIG. 1;

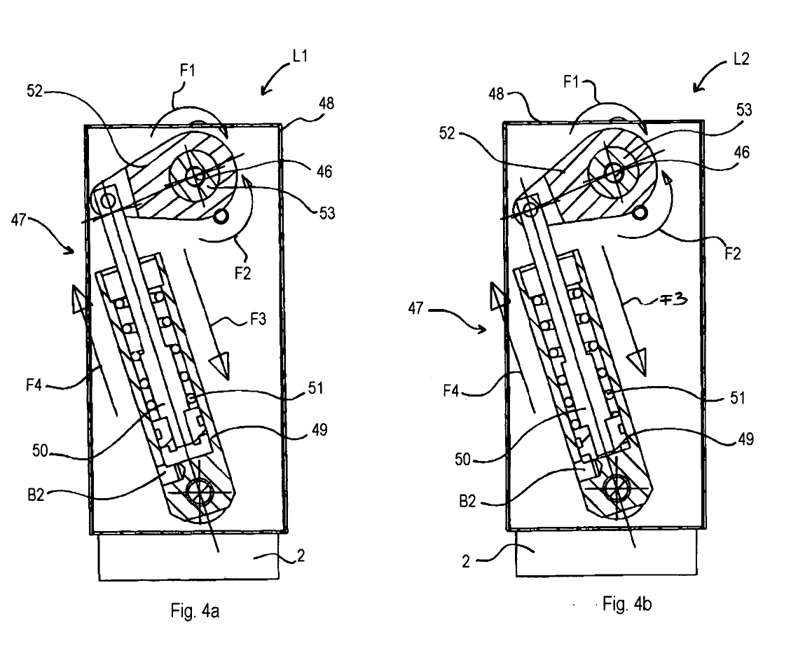

FIG. 4a is a schematic section taken along the plane IV-IV of the dispensing apparatus in FIG. 1 in a first working position;

FIG. 4b is a schematic section taken along the plane IV-IV of the dispensing apparatus in FIG. 1 in a second working position;

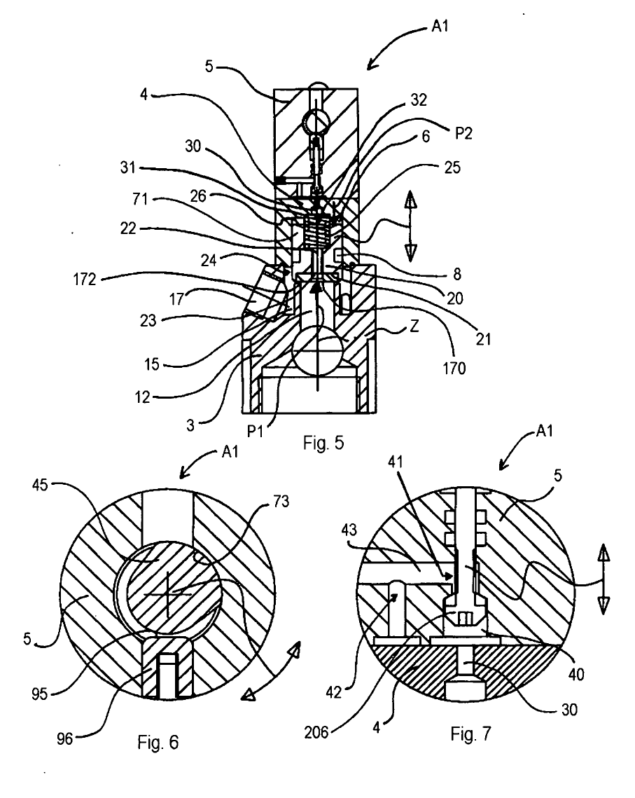

FIG. 5 is a schematic section taken along the plane V-V of the dispensing apparatus in FIG. 1 in a first operating configuration;

FIG. 6 is a section view of an enlarged detail in FIG. 5;

FIG. 7 is a section view like the one in FIG. 6 of a further enlarged detail in FIG. 5;

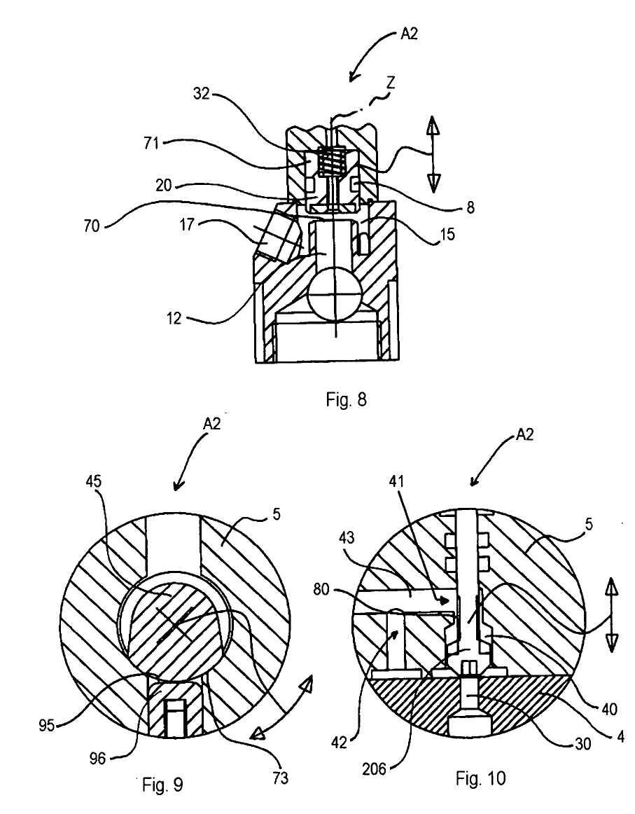

FIG. 8 is a fragmentary schematic section taken along the plane V-V of the dispensing apparatus in FIG. 1 in a second operating configuration;

FIG. 9 is an enlarged detail in FIG. 8;

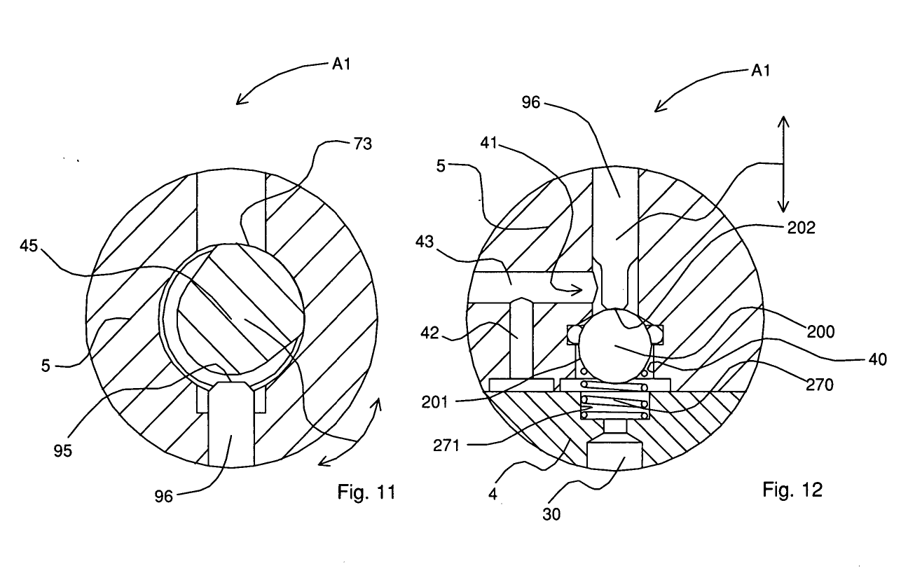

FIG. 10 is an enlarged detail in FIG. 8;

FIG. 11 is a section view of an enlarged detail of a further embodiment of the dispensing apparatus in FIG. 1;

FIG. 12 is a section view of a further enlarged detail of a further embodiment of the dispensing apparatus in FIG. 1;

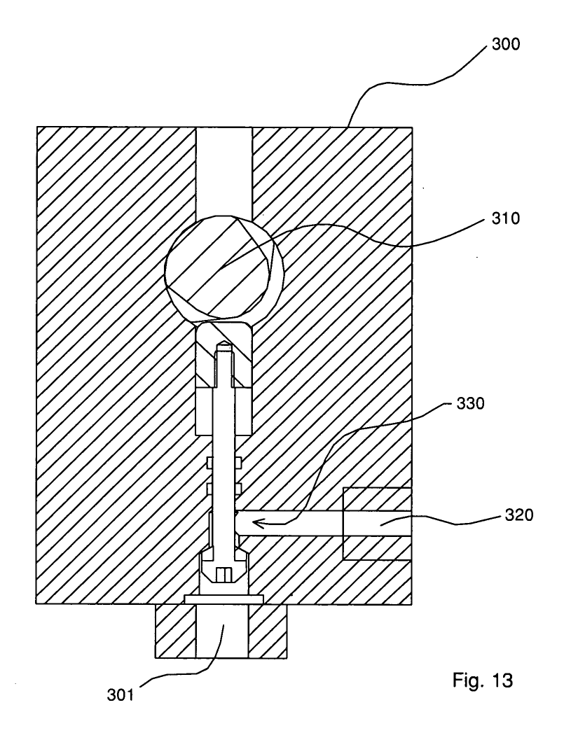

FIG. 13 is a section like the one in FIG. 11 of an air module associable with the dispensing apparatus in FIG. 1. With reference to FIGS. 1 to 3, there is shown a dispensing apparatus 1 arranged for dispensing a flow of water and air to an apparatus for making artificial snow, which is not shown.

The dispensing apparatus 1 is provided with a main body 2 comprising a first block 3, a second block 4 and a third block 5, the second block 4 being interposed between the first block 3 and the third block 5.

The first block 3 comprises a main water intake conduit 10 extending along a first axis X, and arranged for receiving a flow of water coming from a collecting basin, which is not shown.

The main conduit 10 is provided with a first intake conduit 11, a second intake conduit 12 and a third intake conduit 13, extending along directions substantially parallel to a second axis Z, that is transverse to said first axis X.

The first intake conduit 11, the second intake conduit 12 and the third intake conduit 13 lead respectively into a first chamber 14, into a second chamber 15 and into a third chamber 16 obtained in the first block 3.

The first chamber 14, the second chamber 15 and the third chamber 16 communicate with first dispensing conduits 36, second dispensing conduits 17 and with third dispensing conduits 18 arranged for dispensing water to respective nucleating and dispensing nozzles and positioned upstream of the dispensing apparatus 1 and included in the apparatus for making artificial snow.

In other words, in use, the first chamber 14, the second chamber 15 and the third chamber 16 are interposed between the first intake conduit 11, the second intake conduit 12, the third intake conduit 13 and the first dispensing conduits 36, the second dispensing conduits 17 and the third dispensing conduits 18.

The first chamber 14, the second chamber 15 and the third chamber 16 are arranged for receiving respectively, in use, at least a portion of a first valve element 70, a second valve element 71 and a third valve element 72.

The first valve element 70, the second valve element 71 and the third valve element 72 are arranged for adjusting a passage of water respectively between the first intake conduit 11, the second intake conduit 12, the third intake conduit 13 and the first dispensing conduits 36, the second dispensing conduits 17 and the third dispensing conduits 18. The second valve element 71, shown in detail in FIGS. 5 and 8, comprises a valve body 20, extending and movable along the second axis Z, to an end 24 of which a plate 21 is fixed.

The valve body 20 and the plate 21 are provided respectively with a passage 22 and with a hole 23, extending around the second axis Z and substantially concentric.

The passage 22 makes the hole 23 communicate with a recess 25 obtained on an end surface 26 of the valve body 20, the end surface 26 being opposite the end 24.

The valve body 20 is received, in use, in a seat 6 obtained in the second block 4, between the valve body 20 and the seat 6 there being provided seals 8.

The second block 4 is further provided with a connecting conduit 30, extending substantially around the second axis Z.

The connecting conduit 30 is provided with a widened portion 31, facing, in use the recess 25.

The recess 25 and the widened portion 31 are arranged for receiving an elastic element, for example a return spring 32.

The connecting conduit 30, shown in detail in FIGS. 7 and 10, is arranged for connecting the seat 6 to a further seat 40, obtained in the third block 5, extending substantially around the second axis Z.

The further seat 40 is further connected to a discharge conduit 42.

The discharge conduit 42 comprises a first portion 43 obtained in the third block 5 (FIG. 7) and a second portion 44 obtained in the second block 4.

In this way, the discharge conduit 42 connects the further seat 40 to the second chamber 15.

The further seat 40 is arranged for receiving an active portion 206 of a valve element 41 extending and movable along the second axis Z, the valve element 41 being arranged for adjusting a passage of water between the further seat 40 and the discharge conduit 42.

The valve element 41 comprises a sensible member 96 connected to the active portion 206 and provided with an operating surface 95 arranged for interacting, as will be explained better below, with an active profile 73 of a cam 45 (FIGS. 6 and 9).

The cam 45 is positioned on a shaft 46 extending in a direction substantially parallel to the first axis X (FIG. 3).

The first valve element 70 and the third valve element 72 are not disclosed below inasmuch as they are constructionally and functionally similar to the second valve element 71.

It should be noted that the shaft 46 is provided with as many cams as there are the valve elements to drive, the aforesaid cams being mutually equidistant.

The shaft 46 is rotated through pneumatic a driving device 47 (FIGS. 3 and 4) positioned in a box element 48 fixed to a side 400 of the main body 2.

The pneumatic driving device 47 comprises a frame 49.

The frame 49 is provided with an air intake hole 82 into which pressurised air is introduced that is dispensed by the dispensing apparatus, which is not shown.

The frame 49 is further arranged for receiving an actuator 50, between the actuator 50 and the frame 49 there being provided a further return spring 51.

The actuator 50 is connected to a crank 52 mounted on a freewheel 53 fixed to the shaft 46.

The freewheel 53 enables the crank 52 to rotate the shaft 46 in a rotation direction indicated by the first arrow F1 and prevents the crank 52 from rotating the shaft 46 in a further rotation direction indicated by the second arrow F2. In order to drive the actuator 50 it is sufficient to vary, through an adjusting device that is not shown, the nominal air pressure value.

In particular, in use, the actuator 50 is maintained by the pressurised air, dispensed at the aforesaid nominal air pressure, in a raised configuration L1 (FIG. 4a).

When it is desired to vary the dispensing of water the nominal air pressure in the dispensing apparatus is lowered for a certain period of time through the adjusting device.

This period of time must be sufficient for enabling the further return spring 51 to move the actuator 50 in a direction indicated by the third arrow F3 until the further return spring 51 positions the latter in a lowered configuration L2 (FIG. 4b).

The actuator 50, whilst it is moved in the direction indicated by the third arrow F3, rotates the crank 52 in the further rotation direction indicated by the second arrow F2. It should be noted that in turn the crank 52 rotates with respect to the freewheel 53 without transmitting this rotation to the shaft 46.

Subsequently, the adjusting device returns air pressure to the nominal air pressure value.

In this way, the actuator 50 moves from the lowered configuration L2 to the raised configuration L1, moving along a direction indicated by the fourth arrow F4.

The actuator 50, whilst it is moved in the direction indicated by the fourth arrow F4, rotates the crank 52 in the rotation direction indicated by the first arrow F1.

In turn, the crank 52 rotates the freewheel 53, which transmits this rotation to the shaft 46 enabling the latter to rotate by preset angular sectors the cams obtained therein.

The operating modes of the second valve element 71 are disclosed below.

With reference to FIGS. 5 to 7, there is shown the second valve element 71 in a first operating configuration A1.

In the first operating configuration A1 the second valve element 71 prevents a flow of water from flowing from the second intake conduit 12 to the second dispensing conduits 17.

In other words, in the first operating configuration A1, the plate 21 rests on an outlet hole 170 of the second intake conduit 12, shutting the outlet hole 170.

The first operating configuration A1 is made possible by the particular conformation of the valve body 20.

In fact, the valve body 20, owing to the passage 22 and the hole 23, connects the outlet hole 170 with the seat 6.

In this way, on the valve body 20, in the first operating configuration A1, two pressures are exerted having opposite application directions: a first pressure P1 exerted by the water on a surface 172 of the plate 21 and a second pressure P2 exerted by the water on the end surface 26.

As the end surface 26 has an extent that is greater than the surface 172, the second pressure P2 is greater than the first pressure P1, and the valve body 20 remains pressed against the outlet hole 170.

In order to move from the first operating configuration A1 to a second operating configuration A2, shown in detail in FIGS. 8 to 10, in which the second valve element 71 enables the flow of water to flow from the second intake conduit 12 to the second dispensing conduits 17, it is necessary to drive the actuator 50 as previously disclosed.

In other words, it is sufficient to decrease the nominal pressure of the air in the dispensing apparatus of the air through the adjusting device, so as to move the actuator 50 from the raised configuration L1 to the lowered configuration L2 and subsequently return air pressure to nominal air pressure, in such a way as to move the actuator 50 from the lowered configuration L2 to the raised configuration L1.

In this way, by moving the actuator 50 from the raised configuration L1 to the lowered configuration L2 and vice versa, it is possible to rotate the crank 52 and the freewheel 53 by a preset angular sector and consequently rotate the shaft 46 in the direction indicated by the first arrow F1.

Following this rotation, the cam 45 interacts through the active profile 73 with the operating surface 95 of the sensible member 96 that moves the active portion 206 of the valve element 41 along the second axis Z, towards the second block 4.

In this way, a port 80 is defined between the active portion 206 and the further seat 40, which enables the water in the seat 6 to flow into the discharge conduit 42.

This causes an immediate decrease in the second pressure P2 exerted by the water on the end surface 26.

The second pressure P2 becomes less than the first pressure P1 and the valve body 20 is moved away from the second block 4, freeing the outlet hole 170 and enabling the flow of water to flow from the second intake conduit 12 to the second dispensing conduits 17.

To move from the second operating configuration A2 to the first operating configuration A1, it is sufficient to drive again the actuator 50, which will rotate the shaft 46 appropriately.

In an embodiment of the invention, illustrated in FIGS. 11 and 12, the valve element 41 comprises a ball 200 positioned in the further seat 40.

The ball 200 is provided with an active surface 201 arranged for interacting on one side with a further operating surface 202, opposite the operating surface 95, of the sensible member 96 and on another side with another return spring 270 positioned in a housing 271 obtained in the connecting conduit 30.

In use, following rotation of the shaft 46, the cam 45 interacts through the active profile 73 with the operating surface 95 of the sensible member 96, which by means of the further operating surface 202 interacts with the ball 200, moving the latter along the second axis Z towards the second block 4 and compressing the other return spring 271.

In this way, a further port is defined, which is not shown, between the ball 200 and the further seat 40, which enables the water in the seat 6 to flow into the discharge conduit 42.

This causes, as previously disclosed, an immediate diminution of the second pressure P2 exerted by the water on the end surface 26.

The second pressure P2 becomes less than the first pressure P1 and the valve body 20 is moved away from the second block 4, freeing the outlet hole 170 and enabling the flow of water to flow from the second intake conduit 12 to the second dispensing conduits 17.

In order to move from the second operating configuration A2 to the first operating configuration A1, it is sufficient to again drive the actuator 50, which rotates the shaft 46 suitably whilst the other return spring 271 moves the ball 200 along the second axis Z away from the second block 4.

In an embodiment of the invention, shown in FIG. 13, the shaft 46 of the dispensing apparatus 1 is provided with a further cam 310, that is substantially and functionally similar to the cam 45, arranged for driving a further valve element 330 that is substantially and functionally similar to the valve element 41.

The further valve element 330 is inserted into an air dispensing module 300 associated with the dispensing apparatus 1 and arranged for adjusting a flow of air from the air dispensing device to the nucleating nozzles of the apparatus for making artificial snow.

The module 300 comprises an air intake conduit 301 connected to the air dispensing device and an air dispensing conduit 320 connected to the apparatus for making artificial snow, between the air intake conduit 301 and the air dispensing conduit 320 there being interposed the further valve element 330.

The air flow from the air dispensing device to the apparatus for making artificial snow is controlled by the shaft 46 which, through the further cam 45, drives, in the manner disclosed previously, the further valve element 330.

In an embodiment of the invention, which is not shown, the air intake conduit 301 is connected to further air dispensing device arranged for dispensing pressurised air.

In a further embodiment of the invention, which is not shown, the dispensing apparatus 1 is devoid of the first valve element 70, of the second valve element 71 and of the third valve element 72, and the flow of liquid to the apparatus for making artificial snow, similarly to what has been disclosed for the air flow with reference to FIG. 13, is adjusted directly by the valve element 41.

In a still further embodiment of the invention, which is not shown, the dispensing apparatus 1 comprises a further pneumatic driving device, associated with a further side 401, opposite the side 400, of the main body 2.

The further pneumatic driving device is substantially and functionally similar to the pneumatic driving device 47, and for this reason is not disclosed below, and is arranged for improving the operating precision of the shaft 46 and therefore of the dispensing apparatus 1.

It should be noted that it is possible to move the first valve element 70 and the third valve element 72 in the same manner as disclosed for the second valve element 71.

In particular, it should be noted that following any movement of the actuator 50 from the raised configuration L1 to the lowered configuration L2 and vice versa, it is possible to make the dispensing apparatus 1 dispense a variable quantity of water and air to the apparatus for making artificial snow.

It should be further noted that depending on the corresponding position of the cams on the shaft 46 it is possible to drive in a desired phase, or sequence, the first valve element 70, the second valve element 71, the third valve element 72 and the further valve element 330.

Again, it should be noted that the dispensing apparatus according to the invention is controlled by pressure differences or pulses and does not require electric energy to operate, with consequent reductions of the costs associated therewith.

Lastly, it should be noted how, for particular operating requirements, the shaft 46 can be operated manually through a knob 100 associated therewith and projecting from the further side 401.

1. Dispensing apparatus for dispensing a flow of fluid, in particular water and/or air, to an apparatus for making artificial snow, comprising a dispensing valve device arranged for adjusting said flow of fluid to said apparatus, characterised in that there is provided a cam device for moving a sensible member of said dispensing valve device.

2. Dispensing apparatus according to claim 1, wherein said cam device comprises a plurality of cams, each of said cams being arranged for driving in sequence a corresponding dispensing valve of said dispensing valve device.

3. Dispensing apparatus according to claim 1, wherein said dispensing valve device comprises a pilot valve device.

4. Dispensing apparatus according to claim 2, wherein said dispensing valve device comprises a pilot valve device.

5. Dispensing apparatus according to claim 3, wherein said pilot valve device comprises a plurality of pilot valves, each arranged for piloting a corresponding dispensing valve.

6. Dispensing apparatus according to claim 5, wherein each of said pilot valves is interposed between a corresponding cam and a corresponding dispensing valve.

7. Dispensing apparatus according to claim 2, wherein said cams are positioned along a shaft member.

8. Dispensing apparatus according to claim 2, wherein said cams are substantially mutually equidistant.

9. Dispensing apparatus according to claim 1, and comprising a pneumatic actuating device arranged for rotating by preset angular sectors said cam device.

10. Dispensing apparatus according to claim 7, and comprising a pneumatic actuating device arranged for rotating by preset angular sectors said cam device.

11. Dispensing apparatus according to claim 10, wherein a crank element is provided between said shaft member and said pneumatic actuating device.

12. Dispensing apparatus according to claim 11, wherein between said crank element and said shaft member there is interposed a freewheel element.

13. Dispensing apparatus according to claim 9, wherein said pneumatic actuating device is moved by pressurised air.

14. Dispensing apparatus according to claim 10, wherein said pneumatic actuating device is moved by pressurised air.

15. Dispensing apparatus according to claim 9, and comprising an adjusting device for adjusting a dispensing pressure value of said air.

16. Dispensing apparatus according to claim 12, wherein said pneumatic actuating device comprises a pneumatic cylinder arranged for driving said crank element to rotate said freewheel element in a rotation direction.

17. Method for driving fluid a dispensing apparatus arranged for dispensing a flow of fluid, in particular water and/or air, to an apparatus for making artificial snow, comprising controlling a dispensing valve device of said fluid dispensing apparatus, said dispensing valve device being arranged for adjusting said flow of fluid to said apparatus, characterised in that said driving comprises dispensing pressurised air to said fluid dispensing apparatus.

18. Method according to claim 17, wherein said dispensing comprises varying a dispensing pressure value of said air.

19. Method according to claim 18, wherein said varying comprises reducing said dispensing pressure value to a further dispensing pressure value, said further dispensing pressure value being less than said dispensing pressure value.

20. Method according to claim 19, wherein after said reducing returning said further dispensing pressure value to said dispensing pressure value is provided.
